(19) United States
(12) Patent Application Publication
(10) Pub. No.: US 2026/0095928 A1
(43) Pub. Date: Apr. 2, 2026

(54) CAPABILITY SIGNALING FOR POWER EFFICIENT USER EQUIPMENT STATES FOR WIDEBAND UTILIZATION

(71) Applicant: QUALCOMM Incorporated, San Diego, CA (US)

(72) Inventors: Diana MAAMARI, San Diego, CA (US); Gabi SARKIS, San Diego, CA (US); Kianoush HOSSEINI, San Diego, CA (US); Aria HASANZADEZONUZY, Jersey City, NJ (US)

(21) Appl. No.: 18/902,167

(22) Filed: Sep. 30, 2024

(51) Int. Cl. H04W 72/51; H04L 5/00; H04W 8/24

(52) U.S. Cl. CPC H04W 72/51; H04L 5/0098; H04W 8/24

(57) ABSTRACT

Certain aspects of the present disclosure provide techniques for UE capability and efficiency optimizations. Certain aspects include an UE, comprising a processing system that includes one or more processors and one or more memories coupled with the one or more processors, the processing system configured to cause the UE to: the capability information indicating at least one time slot offset corresponding to a maximum scheduling bandwidth for at least one of a number of one or more carriers, or a BC; and communicate based on the capability information.

### FIELD OF THE DISCLOSURE

Aspects of the present disclosure relate to wireless communications, and more particularly, to techniques for user equipment (UE) signaling and capability and efficiency optimizations.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes sending capability information, the capability information indicating at least one time slot offset corresponding to a maximum scheduling bandwidth for at least one of: a number of one or more carriers, or a band combination (BC); and communicating based on the capability information.

Another aspect provides a method for wireless communications by an apparatus. The method includes obtaining capability information, the capability information indicating at least one time slot offset corresponding to a maximum scheduling bandwidth for at least one of: a number of one or more carriers, or a BC; and communicating based on the capability information.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts an example of wideband and narrowband configurations.

FIG. 6 depicts an example of virtual carrier generation via flexible spectrum integration (FSI).

FIG. 7 depicts an example of an adaptive WB configuration activation.

FIG. 8 depicts an example method for communications in a network between an NE and a UE.

FIG. 9 depicts an example of WB configuration activation compared to adaptive WB configuration activation.

FIG. 10 depicts an example table listing UE capabilities and their properties associated with various power states.

FIG. 11 depicts a method for wireless communications.

FIG. 12 depicts another method for wireless communications.

FIG. 13 depicts aspects of an example communications device.

FIG. 14 depicts aspects of an example communications device.

### DETAILED DESCRIPTION

Aspects of the present disclosure provide apparatuses, methods, processing systems, and computer-readable mediums for optimizations to UE efficiency and capabilities.

Modern telecommunication networks, such as those implementing fifth-generation New Radio (5G NR or simply 5G) radio access technologies, may use multiple component carriers (CCs) to improve the performance of a network. A CC may be a segment of a frequency spectrum of a cell in a telecommunications network. A cell may have a particular carrier frequency and bandwidth, and may span a particular coverage area. A cell may be controlled by a base station, and each base station may control multiple cells. A UE may be configured with multiple CCs, including a primary CC (also referred to as a primary cell or PCC) on which control communications and data communications are performed, and one or more secondary CCs (also referred to as secondary cells or SCCs) on which data communications are performed.

A single cell can use one or more CCs. A CC may operate on a specific frequency band within the radio spectrum. For example, a cell may use a 20 MHz CC in one frequency band and a 10 MHz CC in another. These CCs may be combined via carrier aggregation (CA) to provide better service within a cell's coverage area. CCs may also be broken down further into sub-bands (SBs). An SB may be one CC or at least one portion of a CC. Some wireless communication configurations employ multiple cells, SBs, or CCs in certain situations. It should be understood that reference herein to a CC may also refer to an SB. A wideband (WB) configuration is a configuration where any number of CCs are utilized to achieve peak throughput. A WB configuration may include combining CCs on different bands together as a band combination (BC) to form a larger bandwidth to achieve this peak throughput. A WB configuration may alternatively use a single CC to occupy a larger RF range to achieve peak throughput. Throughput may be defined as the rate at which data is successfully transmitted from one point to another (e.g., from an NE to a UE and vice versa). Throughput may indicate the actual speed of data transfer taking into account factors like traffic and transmission errors.

The use of a WB configuration may help increase bandwidth, improve coverage, capacity, and load balancing, and may increase flexibility and efficiency. These aforementioned outcomes may, for example, be achieved by the use of a WB configuration in CA or flexible spectrum integration (FSI). In CA, CCs may be combined and used to communicate simultaneously, which allows for the aggregation of bandwidth from multiple frequency bands. This aggregation may boost data transfer rates and enhance overall network capacity. By contrast, in FSI, CCs may be integrated by unifying their physical layer (PHY) or medium access control layer (MAC) handling. For example, unifying the aforementioned layers may result in a unified virtual CC or cell that may be handled by one scheduling or Hybrid Automatic Repeat request (HARQ) entity. FSI may also include scheduling a transport block (TB) across CCs of bands in a BC, where the CCs may act as one virtual CC or cell. Activating a WB configuration, such as in CA or FSI, may be referred to herein as a wideband configuration activation (WB configuration activation).

In certain instances of large throughputs, an NE may activate a WB configuration. For example, WB configuration activation may occur for a CA or FSI operation, which may include scheduling the use of CCs of a BC for TBs or other data transmissions. Some WB configuration activations may schedule transmissions on all activated band(s) in the BC. In certain instances of WB configuration activation, once CCs are activated, they are assumed to have scheduled activity on them, because by virtue of being activated the CCs may be assumed to have some minimal activities scheduled in connection with the activation, even if there is no user data transmission scheduled on them. For example, in WB configuration activation, the NE may automatically schedule a control channel (CCH) on each activated CC merely due to the CC being activated. In such instances, the UE connected to the NE may respond to the WB configuration activation by entering a default high power state (or even its highest power state) that assumes activity on all activated CCs. This enables the UE to perform timely processing in connection with the WB configuration activation across all the activated CCs. For example, the UE may enter a power state that uses additional power compared to a baseline or average UE power usage, leading to increased power consumption. A high power state of a UE may involve a higher clock frequency (e.g., a higher baseband clock frequency), a higher supply voltage to support the higher clock frequency, and/or a radio frequency configuration that supports a full bandwidth of all the CCs.

Therefore, in certain instances of WB configuration activation, the UE may automatically enter a higher power state because it may allow the UE maximum flexibility to utilize all CCs in the WB BC. The higher power state may allow the UE to respond with minimal delay in situations involving high throughput or low latency from the NE, as the UE may already be in a high power state and thus able to quickly deploy a high level of compute resources. A high power state therefore may allow a UE maximum use of compute or radio resources with minimal delay. However, not all of these activated CCs are always used by the NE for substantive data transmissions (e.g., transmissions of user data). The NE may activate the maximum number of CCs in a WB for a UE, but only schedule data communications on a portion of the CCs. This means that a UE may needlessly run at a power state than is higher than is actually needed by scheduled user data transmissions. This automatic activation of a high power state by a UE in response to WB configuration activation by an NE may therefore lead to excess power usage, excess heat output, and inefficient battery drain by the UE.

By contrast, a WB configuration activation referred to herein as an adaptive WB configuration activation may decouple activation of CCs from scheduling activity on the activated CCs. For example, under adaptive WB configuration activation, a CC may be activated but have no transmission activity scheduled on it at all, such that the activated CC is only held in reserve. This may enable the UE to use a lower power state, such as one that uses a clock frequency, supply voltage, and/or radio frequency configuration corresponding to a proper subset of the activated CCs, thereby reducing processor usage and saving power. However, different UEs may have different capabilities for adaptive WB configuration activations, such as a number of CCs that can be supported for a particular BC, a maximum scheduling bandwidth that can be supported for the particular BC, or a time slot offset that can be used given a particular BC or number of CCs. Without knowledge of the capabilities of a specific UE, the NE may configure an adaptive WB configuration activation that exceeds the capabilities of the specific UE (thereby causing failure of communications or increased energy consumption) or does not fully utilize the capabilities of the specific UE (thereby reducing throughput).

The technologies presented herein may include UE capability signaling, wherein the UE indicates its capabilities to an NE. The capabilities may relate to configuration or activation of an adaptive WB configuration activation, such as time slot offsets corresponding to a maximum scheduling bandwidth for a number of one or more CCs, or for a BC. Upon receiving the indication of a UE's capabilities, the NE may perform an adaptive WB configuration activation or communicate the adaptive WB configuration activation to the UE based on the UE's capabilities.

The UE signaling its capabilities to the NE allows the NE to know the capabilities of the UE to tailor the adaptive WB configuration activation based on these capabilities to maximize efficiency and quality outcomes. For example, if the UE indicates that it can handle a number of CCs in a specific BC, then the NE may activate the number of CCs for the UE at a high power state, and may activate a lower number of CCs or schedule activities on a lower number of activated CCs for other power states that emphasize efficiency over performance. Further, the mutual understanding of capabilities, allows the NE to ensure that it does not configure excess CCs not usable by the UE that may otherwise be used by other UEs. Therefore, this mutual understanding based on the UE capability signaling allows more efficient use both on the NE side in configuration of resources and CCs, and on the UE side in the power state the UE utilizes.

The technologies presented herein provide systems, methods and apparatuses to achieve appropriate power states of a UE according to the UE's capabilities as indicated in its capability signaling to the NE. The NE may then respond with adaptive WB configuration activation tailored to the indicated UE's capabilities. This adaptive WB configuration activation allows the UE to be more energy efficient. The NE may provide the UE with an indication of the CCs that have activities scheduled or to be scheduled by the NE for transmission according to the UE's capability signaling. In some aspects, therefore, the indication of the adaptive WB configuration activation may inform the UE of not only the CCs that are activated but may also indicate the scheduled transmissions on the activated CCs (or that transmissions are scheduled on the activated CCs). The indication may allow the UE to respond proportionately and efficiently. For example, when responding efficiently and proportionately to the scheduling of adaptive WB configuration activation CCs, the UE may stay out of the highest power state upon WB activation instead of entering it automatically. In the disclosed technologies, the UE may select from multiple possible power states that the UE may implement proportionate to the indications of the adaptive WB configuration activation it receives from the NE, where the adaptive WB configuration activation is based on the UE's capability signaling.

One technical benefit of the technologies herein is to reduce power consumption by a UE. Because a UE may no longer automatically enter the highest power state upon WB configuration activation, but may instead adjust its power state or select from a number of power states, the UE will not use power at a rate that is higher than a rate used to support an activated adaptive WB configuration. The UE may therefore use power in an efficient power state based on the provided indication and may draw power at lower rates than the high or highest power states it would otherwise enter upon a WB configuration activation. For example, if a UE is running at a low battery level, it may indicate to the NE that it is only able to perform transmissions on a maximum number of CCs to minimize battery drain. The NE may then only configure a small number of CCs of bands in the BC and indicate this to the UE.

Another technical benefit of the presented technologies is to reduce compute resource usage by a UE. Compute resources may include processing, memory and storage resources. When an NE activates a WB configuration and the UE enters a high power state, then compute resources are used for potential high power state activities. Many of these resources may be unnecessary, since not all activated CCs will have scheduled activity on them. Therefore, by providing an indication of the scheduled activity and the number of CCs that will be used via the adaptive WB configuration activation based on the UE's capability signaling, then the UE is able to use an efficient amount of compute resources and not over-allocate or overuse resources for activities on the BC. This frees up compute resources for other processes, and also reduces total resource usage, which reduces power usage.

Another technical benefit is to optimize UE states to result in efficient compute resource and power usage to meet key performance indicators (KPIs) such as latency or power usage. An NE may have various different requirements for different types of transmissions. For example, the NE may have a first requirement in ultra-reliable low-latency communication (URLLC) scenarios, which is a use case characterized by the need for low latency with very high reliability. As another example, the NE may have a second requirement in a baseline scenario (e.g., adaptive mobile broadband (eMBB) communication). In the former scenario, the UE may have to provide very low latencies (which may involve a high power state), while in the second scenario, the NE may prioritize energy savings and efficiency over latency. The technologies presented herein may allow a UE to enter a suitable power state based on the KPIs of an NE or communication and based on NE-provided indications about the adaptive WB configuration activation.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

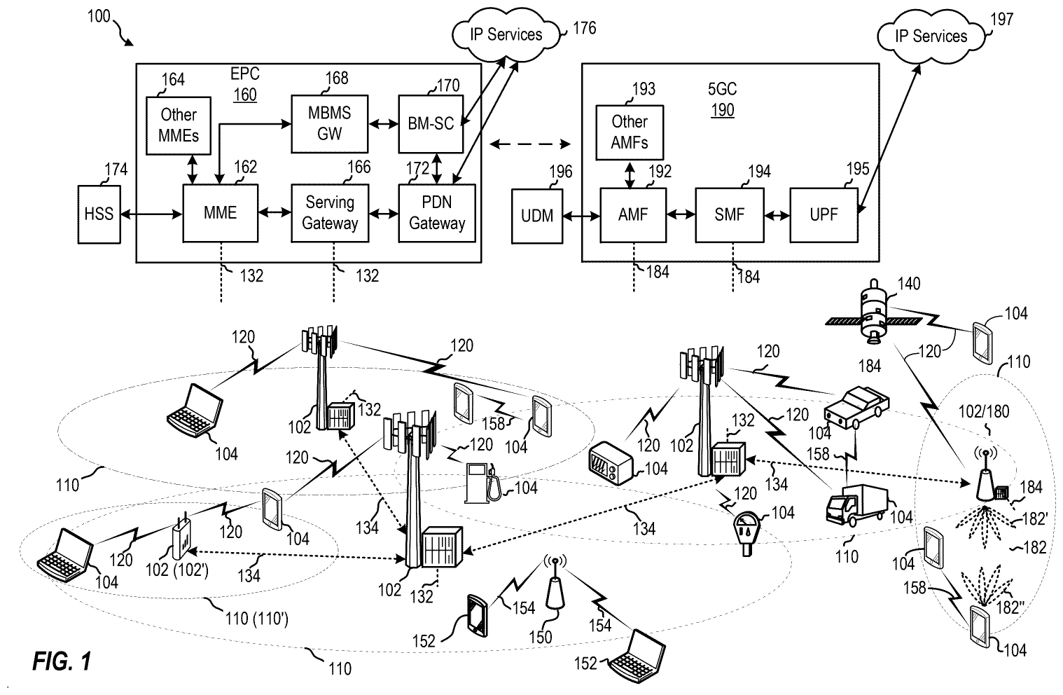

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” (NE) can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an adaptive NodeB (eNB), a next generation adaptive NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

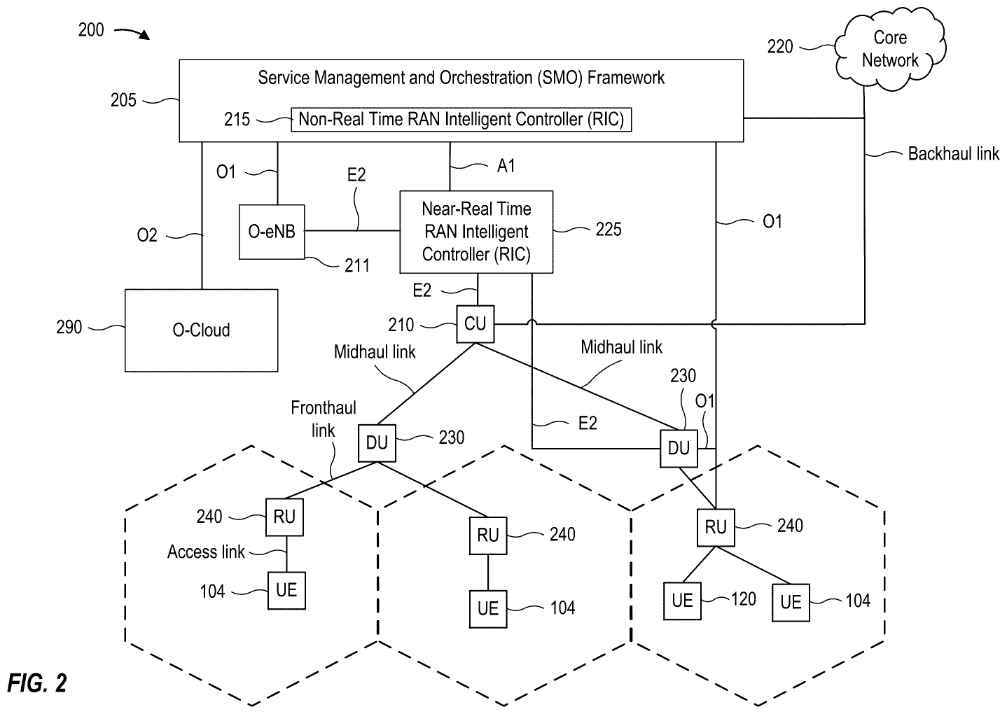

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a sub-band. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., an mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182′′. UE 104 may also transmit a beamformed signal to the BS 180 in one or more transmit directions 182′′. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a Wi-Fi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

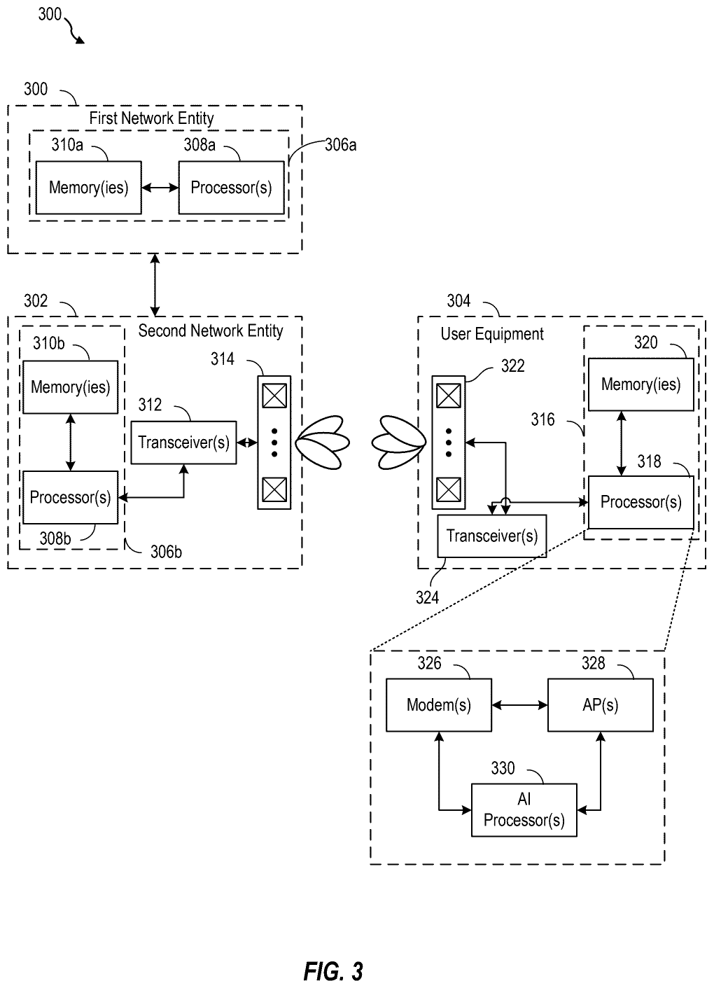

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

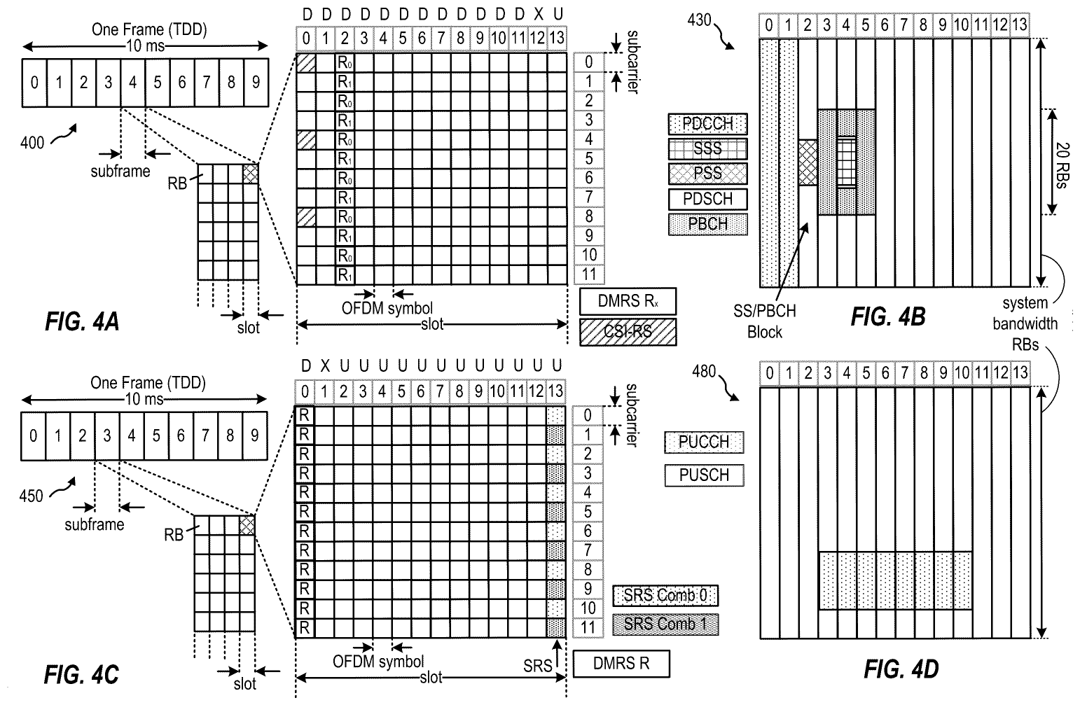

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2 slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to UE Capability Signaling for Efficiency Optimizations

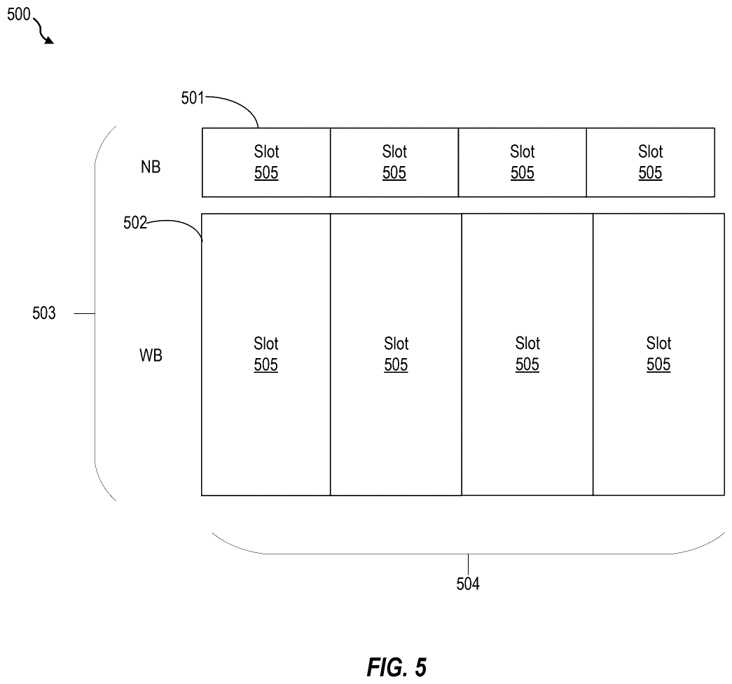

FIG. 5 depicts an example 500 of WB and narrowband (NB) configurations. In example 500, the vertical axis represents frequency and the horizontal axis represents time. The operations of example 500 may be performed by a UE and/or an NE. In some aspects, a UE corresponds to the UE 104 of FIG. 1 or the UE 304 of FIG. 3. In some aspects, an NE corresponds to the BS 102 of FIG. 1, the first network entity 300, or the second network entity 302 of FIG. 3.

The example 500 includes an NB 501 and a WB 502. In this example 500, the NB 501 occupies a narrower or smaller range of frequencies 503 than does the WB 502. The example 500 presents the NB 501 and the WB 502 as occupying the same range of a time interval 504. The time interval 504 may be comprised of time slots 505. The time slots 505 are time durations that may be scheduled or allocated for transmitting data, control information, or to perform other activities (e.g., signal measurements).

In some aspects, the NB 501 uses less power per time slot 505 than the WB 502, since the UE may use a narrower RF filter and/or a slower baseband clock speed for the NB 501 than for the WB 502. A WB may be defined as a set of CCs (or SBs, which may be referred to herein as CCs) in a WB configuration. In some aspects, the WB 502 may be configured to achieve peak throughput of a UE. Meanwhile an NB such as the NB 501 may be defined as a set of CCs that occupy a range of frequencies 503 that is not capable of achieving peak throughput and thus may operate on a narrower frequency range than the WB 502. It should be noted that the techniques described herein can be implemented by any of the devices, apparatuses, systems, and methods disclosed herein.

A WB 502 may be suitable for peak throughputs, but due to its high power usage may tend to be used in bursts. For example, the WB 502 may support a burst of peak throughput transmission in a set of time slots 505. If the NE prefers to reduce energy usage, the NE may activate or configure the NB 501. Alternatively if the NE determines to increase transmission of data, the NE may activate the WB 502.

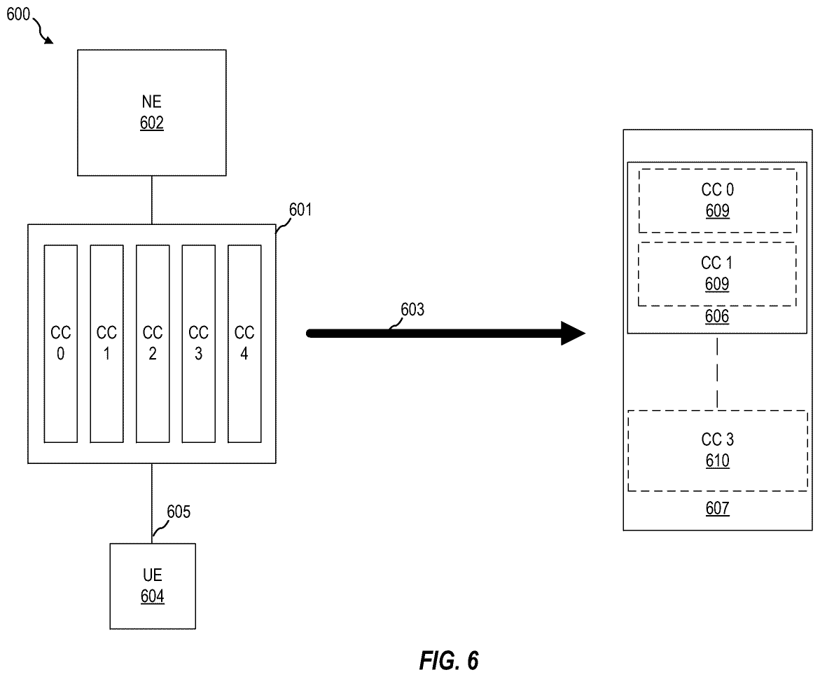

FIG. 6 depicts an example 600 of FSI.

In some aspects, the example 600 may comprise a UE 604 that corresponds to the UE 104 of FIG. 1 or the UE 304 of FIG. 3. In some aspects, the example 600 may comprise an NE 602 that corresponds to the BS 102 of FIG. 1, the first network entity 300 or the second network entity 302 of FIG. 3. The UE 604 and the NE 602 may be configured with a set of CCs 601 on a connection 605.

FSI may be employed at 603 on the set of CCs 601 to generate a virtual CC 607. The FSI at 603 may include various techniques to integrate the set of CCs 601 into the virtual CC 607. For example, the set of CCs 601 may be integrated at 603 by performing unified physical (PHY) layer or medium access control (MAC) layer handling to form the virtual CC 607. The virtual CC 607 may act as one scheduling or HARQ entity.

Thus, FSI may provide a single CC (the virtual CC 607) from a scheduling and HARQ point of view. A single CC of the set of CCs 601 may carry the PDCCH for scheduling. Thus, FSI may provide a smaller number of decoding attempts and a narrower radio frequency range for the PDCCH than configuring multiple separate CCs each with their own search space. Furthermore, retransmissions across the set of CCs 601 may be unified (e.g., on a designated CC or set of CCs), thereby improving diversity.

In some aspects, a virtual CC 607 may be associated with a non-contiguous active BWP 606. For example, the non-contiguous active BWP 606 may be configured across two or more CCs of the set of CCs 601. A single TB may be scheduled on the non-contiguous active BWP 606. Thus, frequency division duplexing (FDD) channels that are separated in frequency may be aggregated in the virtual CC 607 with single-TB scheduling. Additionally, or alternatively, multi-TB scheduling with a single-CC PDCCH may be performed, in which multiple TBs are scheduled using a PDCCH on a single CC.

### Example Signaling of User Equipment (UE) Capabilities for Adaptive WB Configuration Activations

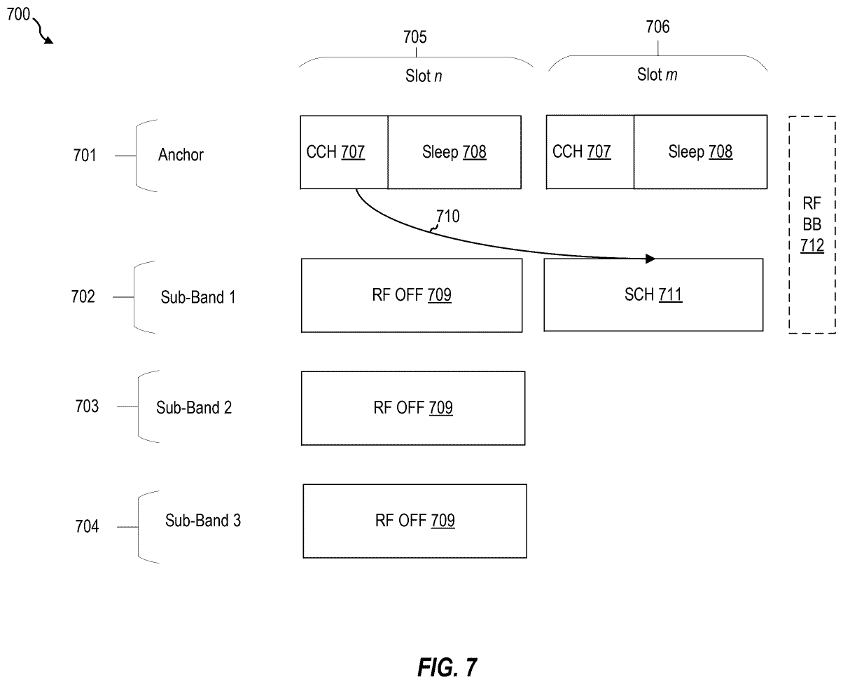

FIG. 7 depicts an example 700 of an adaptive WB configuration activation.

In some aspects, a UE in FIG. 7 corresponds to the UE 104 of FIG. 1 or the UE 304 of FIG. 3. In some aspects, an NE in FIG. 7 corresponds to the BS 102 of FIG. 1, or the first network entity 300 or the second network entity 302 of FIG. 3.

The adaptive WB configuration activation may comprise a set of CCs which are activated by the NE. In some aspects, the set of CCs may include an anchor CC (anchor) 701, and three sub-bands (SBs) 702, 703, and 704. As mentioned elsewhere, references to a CC herein are also intended to disclose an SB. For example, a set of CCs may include one or more CCs, one or more SBs, or a combination thereof. In some aspects, the anchor 701 is used for control signaling. In some aspects, the SBs 702, 703, and 704 are used for data transfer, such as user data transfers between the NE and the UE. In some aspects, each of these CCs 701-704 may have activities (e.g., transmissions) scheduled on them in time slot 705 or time slot 706. In some aspects, no activities are scheduled on the CCs 701-704 across the time slots 705 and 706. In some aspects, the anchor 701 may have a bandwidth of 20 MHz, and the SBs 702, 703, and 704 may have a bandwidth of 100 MHz.

The anchor 701 may include a CCH 707 scheduled on the time slots 705 and 706 or on a portion of each of the time slots 705 and 706. The CCH 707 may carry control information for each CC of the set of CCs. For example, the CCH 707 may schedule a shared channel (SCH) 711 on SB 702, as described below. In some aspects, the anchor 701 may enter a sleep mode 708 when there is nothing scheduled in a time slot 705 or 706 or a portion of the time slot 705 or 706. In some aspects, the sleep mode 708 may be a micro-sleep.

In some aspects, one or more CCs of the set of CCs may not have activity scheduled on the time slots 705 and 706. For example, there may be no transmissions scheduled on the SB 703 and the SB 704. As another example, the UE may receive an indication that the SB 703 and/or the SB 704 will not be scheduled in the time slot 705 or the time slot 706. Therefore, in some aspects, the SBs 703 and 704 may enter into an RF off mode 709. In some aspects, an RF off mode 709 is a mode where RF hardware for a CC is turned off. In some aspects, some CCs of the set of CCs may have scheduled activity on some time slots, but not other time slots. For example, SB 702 may have no activity scheduled, and may thus enter an RF off mode 709 at the time slot 705. However, the SB 702 may have the SCH 711 scheduled by a control signal on the anchor 701 in the time slot 706. Therefore, in the time slot 706, a BB clock and RF configuration 712 of the UE may be derived from a total bandwidth of the anchor 701 and the SB 702 (e.g., 120 MHz), thereby reducing power consumption relative to a BB clock and RF configuration that is derived from a full bandwidth of the set of CCs (e.g., 320 MHz).

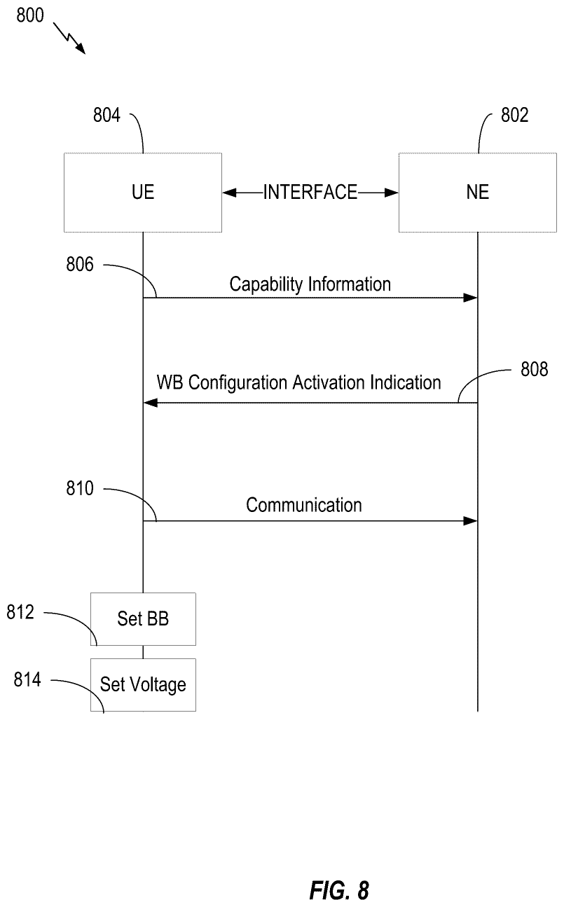

FIG. 8 depicts an example 800 for communications in a network between an NE and a UE.

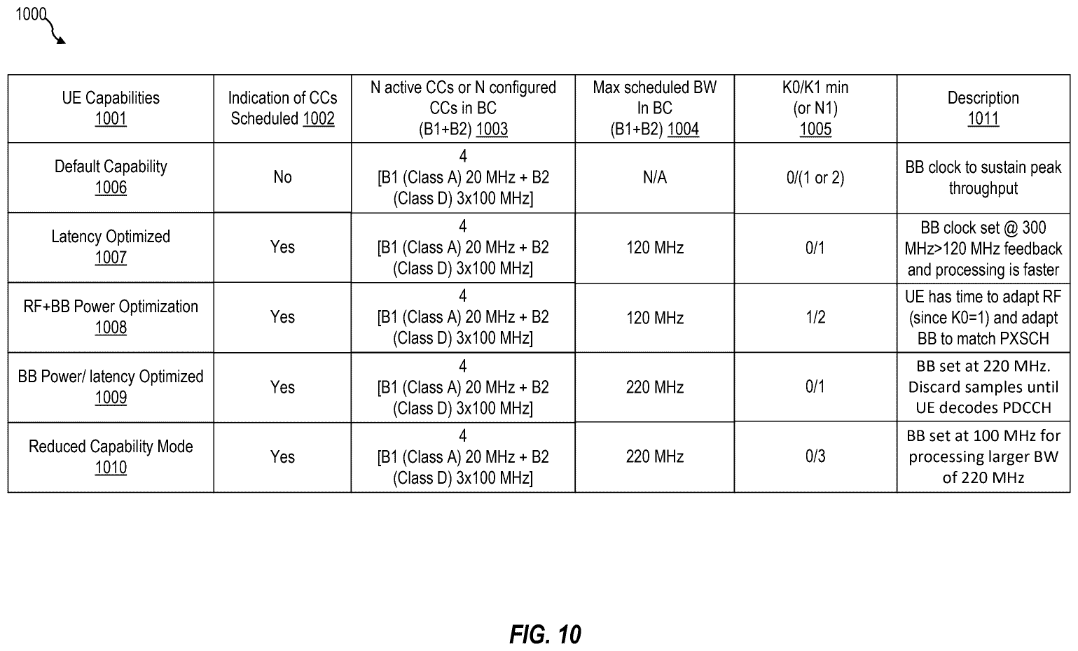

In some aspects, FIG. 8 may comprise a UE 804 and an NE 802. In some aspects, the UE 804 may correspond to the UE 104 of FIG. 1 or the UE 304 of FIG. 3. In some aspects, the NE 802 may correspond to the BS 102 of FIG. 1, the first network entity 300, or the second network entity 302 of FIG. 3. In some aspects, the example 800 begins at 806 with the UE 804 sending, and the NE 802 obtaining, capability information. The capability information may be UE capability information. In some aspects, the capability information may indicate the UE's capability in regards to a WB configuration activation, such as an adaptive WB configuration activation. In some aspects, the capability information may indicate at least one time slot offset corresponding to a maximum scheduling bandwidth for at least one of a number ‘x’ of one or more CCs, or for a BC (e.g., a predefined BC). For example, the capability information may indicate a number of CCs, a BC, or a combination thereof. In association with the number of CCs and/or the BC, the capability information may indicate one or more of a time slot offset or a maximum scheduling bandwidth. Thus, the capability information may indicate a maximum scheduling bandwidth, time slot offset, and/or number of CCs supported for a given band combination. In some aspects, the capability information may comprise any of the information disclosed in relation to the example table 1000 in FIG. 10.

In some aspects, the one or more CCs may correspond to the CCs of the set of CCs 601 of FIG. 6, or to the CCs 701-704 of FIG. 7. In some aspects, the capability information may be an indication of a capability in regards to a number of CCs that may be activated, a number of CCs that may have activity scheduled on them, types of activities that may be scheduled, as well as any time slot information such as time slot offsets that may affect scheduling of transmissions or response time of scheduled activities on the CCs of the BC. For example, for a given BC, the capability information may indicate that the UE supports 4 active CCs with a maximum scheduling bandwidth of 120 MHz, and a time slot offset of 1 slot.

In some aspects, a time slot offset may comprise or be defined by a k₀, k₁, or k₂ parameter that defines a timing relationship between different types of transmissions. The k₀ parameter (which may be referred to as a first parameter) may indicate a number of time slots between a PDCCH or a DCI and a downlink data transmission scheduled by the DCI. The k₁ parameter (which may be referred to as a second parameter) may indicate a number of time slots between a PDSCH and a HARQ transmission relating to the PDSCH. The k₂ parameter (which may be referred to as a third parameter) may indicate a number of time slots between a PDCCH or a DCI and an uplink data transmission. In some aspects, the time slot offset may indicate a minimum value of the parameter. For example, the time slot offset indicated by the capability information may indicate a minimum value of k₀, k₁, or k₂.

In some aspects, at 808 the NE 802 may send, and the UE 804 may obtain, an indication of an adaptive WB configuration activation. In some aspects, the adaptive WB configuration activation is based on the indication of capability information that was obtained by the NE 802 at 806. For example, the adaptive WB configuration activation may conform to parameters of the capability information. As a more particular example, the UE 804 may at 806 indicate to the NE 802 a capability of activation of a maximum of three CCs for a given BC. If the NE 802 wants to maximize throughput and thus the number of activated CCs (e.g., where the NE 802 activates four CCs at maximum by default), then the NE 802 may activate only three CCs as a maximum, based on the maximum number the UE 804 indicated it is capable of. The adaptive WB configuration activation indication sent at 808 by the NE 802 and obtained by the UE 804, may be referred to herein as the NE communicating based on the capability information.

In some aspects, the indication of the adaptive WB configuration activation obtained by the UE 804 at 808 may include first information and second information, wherein the first information is associated with at least one time slot offset. For example, the first information may identify the at least one time slot offset. In some aspects, the second information is associated with one or more CCs (e.g., CCs or SBs). For example, the second information may indicate a maximum scheduling bandwidth for the one or more CCs of a given BC.

In some aspects, a maximum scheduling bandwidth comprises information regarding a maximum schedulable bandwidth. For example, a maximum schedulable bandwidth may indicate a maximum cumulative bandwidth of all active CCs that are indicated for communication at a given time in a BC. In some aspects, a maximum scheduling bandwidth indicates a maximum actually scheduled bandwidth. A maximum actually scheduled bandwidth may indicate a maximum bandwidth on which data transmission (via a shared channel) is actually scheduled. In some aspects, the maximum scheduling bandwidth may be specific to a band, such as a band of a BC. Additionally, or alternatively, the maximum scheduling bandwidth may be specific to a BC.

In some aspects, the maximum scheduling bandwidth may include information regarding a maximum number of schedulable CCs of the one or more CCs in the BC. For example, the maximum scheduling bandwidth may indicate how many CCs can be activated for scheduling in a given BC. Additionally, or alternatively, the maximum scheduling bandwidth may include information regarding a maximum number of scheduled CCs of the one or more CCs in the BC. For example, the maximum scheduling bandwidth may indicate how many CCs can be simultaneously scheduled with communications in the BC. Additionally, or alternatively, the maximum scheduling bandwidth may include information regarding a maximum number of schedulable carriers of the one or more carriers per band in the BC. Additionally, or alternatively, the maximum scheduling bandwidth may include information regarding a maximum number of scheduled carriers of the one or more carriers per band in the BC.

In some aspects, the maximum scheduling bandwidth may include a scaling factor. In some aspects, the scaling factor may represent an actually scheduled bandwidth. For example, the scaling factor may be used to scale a total bandwidth of a set of CCs in order to determine a maximum actually scheduled bandwidth. In some aspects, the scaling factor may represent a scheduled bandwidth. For example, the scaling factor may be used to scale a total bandwidth of a set of CCs in order to determine a maximum bandwidth of activated CCs of the set of CCs.

In some aspects, the indication of the WB configuration activation indicates a UE state. For example, the indication may indicate a UE state the UE 804 should enter. In some aspects, the UE state is associated with a CCH configuration. A CCH configuration may indicate a number or arrangement of CCs on which the UE is to monitor for a CCH. In some aspects, the UE states may include a default state, a latency optimized state, or a power optimized state. For example, in the default state, the UE may monitor a PDCCH on all active CCs. In some aspects, the NE 802 may assume that the UE is only capable of the default state if the NE 802 does not receive UE capability information at 806. In the latency optimized state, the UE may monitor a PDCCH on an anchor CC (e.g., the anchor 701 of FIG. 7) and one additional CC of the set of CCs (e.g., one of the SBs 702-704 of FIG. 7). In the power optimized state, the UE may monitor the PDCCH on one CC (e.g., one CC of the set of CCs 701-704 of FIG. 7).

Additionally, or alternatively, the UE state may indicate one or more time slot offsets. For example, the default state may be associated with a first k₀ and/or k₁ value, the latency optimized state may be associated with a second k₀ and/or k₁ value, and the power optimized state may be associated with a third k₀ and/or k₁ value.

In some aspects, the NE 802 may configure the UE 804 with one or more UE states. For example, the NE 802 may configure the one or more UE states according to the capability information (e.g., the NE 802 may configure only UE states that the UE 804 has indicated support for). The NE 802 may perform this configuration via RRC signaling, in some aspects. In some aspects, the NE 802 may provide an indication of which UE state, of these configured UE states, to use. For example, the NE 802 may provide this indication in the indication of the WB configuration activation. Additionally, or alternatively, the NE 802 may provide this indication via Layer 1 signaling such as DCI or Layer 2 signaling such as MAC signaling (e.g., a value in the DCI or MAC signaling may indicate which UE state to use).

In some aspects, at 810, the UE 804 may communicate based on the capability information. For example, the UE 804 may send or receive a transmission on a CC that is scheduled for transmission by the NE 802. Furthermore, for example, the UE 804 may set a BB clock based on the capability information. For example if the UE 804 indicated capability information of three maximum CCs to the NE 802, then the UE 804 may set a BB clock corresponding to three CCs. For example if each CC has a bandwidth of 100 MHz, then the UE, based on the maximum of three CCs, may set its BB clock in accordance with a total bandwidth of 300 MHz.

In some aspects, the UE 804 may set a BB clock at 814 based on the WB configuration activation. For example, if each activated CC has a bandwidth of 100 MHz, and two CCs are activated, the UE 804 may set its BB clock in accordance with a bandwidth of 200 MHz. In some aspects, the UE 804 may at 814 set a supply voltage based on the WB configuration activation. For example, the UE 804 may set a supply voltage in accordance with a number of activated or scheduled CCs. In some aspects, the supply voltage set at 814 by the UE 804 may be directly associated with the BB clock. For example, a higher BB clock at 812 may correspond to a higher supply voltage at 814.

In some aspects, the UE 804 may switch from a first UE state of the UE to a second UE state of the UE based on a delay. For example, the delay may be a transmission delay that exceeds a threshold. In some aspects, the threshold may be a time period exceeded. In some aspects, the threshold is associated with the adaptive WB activation configuration. For example, the NE 802 may set the threshold or include the threshold as part of the adaptive WB activation configuration indicated to the UE 804 at 808. In some aspects, the delay may also be reported in a delay status report, for example, from the UE 804 to the NE 802. The UE 804 may switch to another power state, such as the latency optimized state based on the delay status report being sent, the delay exceeding the threshold, or both.

In some aspects, the UE 804 or the NE 802 may indicate a dynamic update recommendation to the NE 802 or to the UE 804, respectively. The dynamic update recommendation may be for an initial configuration in DCI/UCI, or MAC-CE. In some aspects, the dynamic update recommendation may be sent as part of UE Assistance Information (UAI). In some aspects, the dynamic update recommendation is confirmed or accepted by the UE 804 or the NE 802 that receives it, so that the dynamic update may be implemented.

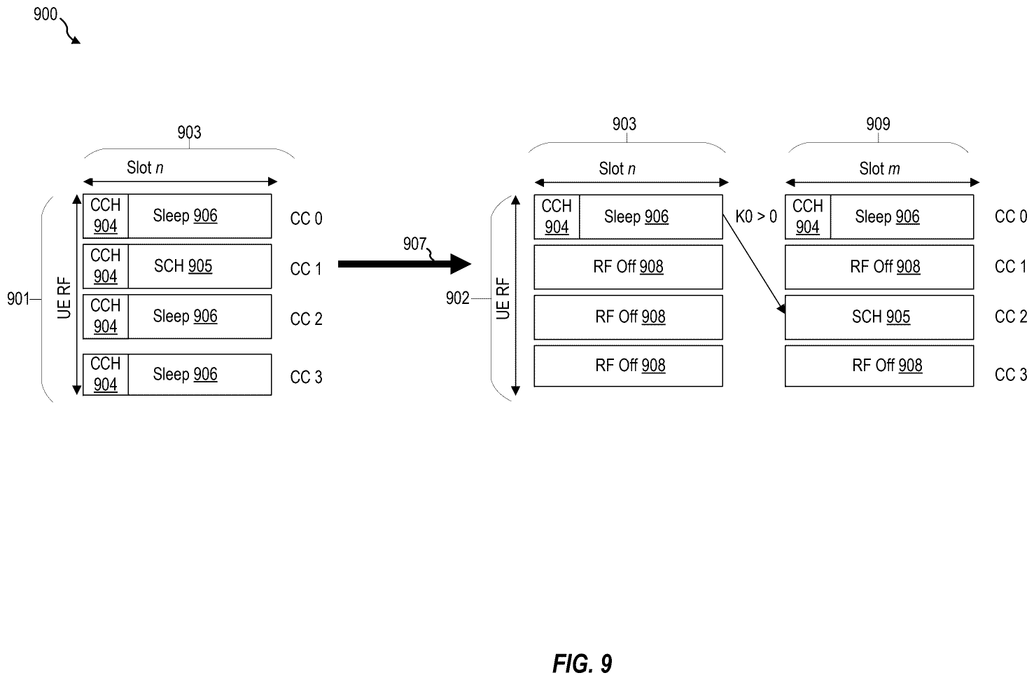

FIG. 9 depicts an example 900 of a WB configuration activation compared to an adaptive WB configuration activation.

In some aspects, a UE in FIG. 9 corresponds to the UE 104 of FIG. 1 or the UE 304 of FIG. 3. In some aspects, an NE in FIG. 9 corresponds to the BS 102 of FIG. 1, the first network entity 300, or the second network entity 302 of FIG. 3.

The example 900 depicts a WB configuration activation of a set of CCs 901 and an adaptive WB configuration activation of a set of CCs 902. In the example 900, the set of CCs 901 comprises four CCs, though other sets of CCs may include different numbers of CCs. The set of CCs 901 may correspond to the set of CCs 601 of FIG. 6 or to the CCs 701-704 of FIG. 7. In the example 900, in the WB configuration activation of the set of CCs 901 in the time slot 903, each CC of the set of CCs 901 has a CCH 904 scheduled on it. One CC is scheduled with a data transmission 905 on it, while three CCs of the set of CCs 901 go into a sleep mode 906 during the time slot 903 subsequent to the CCH 904. However, the UE may still monitor a CCH 904 in each CC of the set of CCs 901. Therefore, even if the set of CCs 901 includes three CCs that go into a sleep mode 906 and that remain unused for the remainder of the time slot 903 with no scheduled data transmissions 905, the set of CCs 901 will cause a UE to enter a default peak power state to handle all four CCs that have been activated.

The example 900 also illustrates an adaptive WB configuration activation for a set of CCs 902. The example of set of CCs 902 has a total of four activated CCs, and CCH 904 is configured on only one CC across time slot 903 and time slot 909. In each of the time slots 903 and 909, the CC with the CCH 904 may enter a sleep mode 906 subsequent to the CCH 904.

The data transmission 905 is then scheduled on another CC other than the CC with the CCH 904. The CC scheduled with the data transmission 905 in the time slot 909 may be in an RF off mode 908 in the time slot 903 prior to the data transmission 905 that is scheduled in the time slot 909. The two remaining CCs of the four activated CCs of the set of CCs 902 have no scheduled activity on either of the time slot 903 or the time slot 909, and therefore are in an RF off mode throughout the time slots 903 and 909.

FIG. 10 depicts an example table 1000 of UE capabilities and their properties associated with various power states.

In some aspects, a UE in FIG. 10 corresponds to the UE 104 of FIG. 1 or the UE 304 of FIG. 3. In some aspects, an NE in FIG. 10 corresponds to the BS 102 of FIG. 1, the first network entity 300, or the second network entity 302 of FIG. 3. A UE may report a UE capability of table 1000 in capability information, which is described in connection with FIG. 8.

The example table 1000 comprises a set 1001 of example UE capabilities. Some of the listed capabilities of the set 1001 of example UE capabilities and their associated information in columns 1002-1005 may correspond to the UE capability information sent by the UE 804 at 806 of FIG. 8 to the NE 802 of FIG. 8. The set 1001 of the example UE capabilities may include a default capability 1006 (e.g., a default state used in WB configuration activation) as well as capabilities 1007-1010 that may be used by a UE for adaptive WB configuration activation.

In some aspects, column 1002 of the example table 1000 lists whether the NE provides an indication (e.g., an early indication) of CC scheduling to the UE. This indication may indicate whether a given CC is scheduled with a communication, which enables the UE to enter an RF off state with regard to the given CC if no communication is scheduled, as described herein. In the default capability 1006, the UE indicates no support for such an indication. In the capabilities 1007-1010, the UE indicates support for such an indication.

The example table 1000 also includes a column 1003 listing a number of CCs activated for each UE capability of the set 1001 of capabilities, a CA bandwidth class (e.g., Class A or Class D) of each UE capability, and respective bandwidth information for each activated CC. For each capability of table 1000, the UE supports a single CC of 20 MHz with a Class A CA bandwidth class and three CCs of 100 MHz each with a Class D CA bandwidth class.

The column 1004 of the table 1000 lists the maximum scheduling bandwidth of a BC (or each band of a BC, as described elsewhere herein) for each UE capability of the set 1001. As shown, a default capability 1006 is associated with no maximum scheduled bandwidth (since the default capability is not subject to indication of scheduled CCs as described with regard to column 1002), capabilities 1007 and 1008 have a maximum scheduled bandwidth of 120 MHz in a BC, and capabilities 1009 and 1010 have a maximum scheduled bandwidth of 220 MHz in the BC.

The example table 1000 also includes a column 1005 that indicates time slot offsets for various UE capabilities of the set 1001. For example, information on the number of offsets for parameters such as k₀, k₁, or k₂. The column 1005 may indicate a respective minimum time slot offset (or multiple minimum time slot offsets) for each capability. For example, the column 1005 may indicate a minimum value of k₀, k₁, or k₂. Additionally, or alternatively, the column 1005 may indicate a minimum value of N₁, which indicates a minimum time duration from decoding a PDCCH for the UE to be ready for reception of a PDSCH scheduled by the PDCCH. Additionally, or alternatively, the column 1005 may indicate a minimum value of N₂, which indicates a minimum time duration from decoding a PDCCH to be ready for a PUSCH transmission scheduled by the PDCCH.

The example table 1000 also comprises a description column 1011 that may include information on a BB that is set for the UE for each capability of the set 1001. For example a higher BB may allow faster processing, and may involve higher power consumption.

The example table 1000 comprises the default capability 1006 for use in WB configuration activation. The default capability 1006 does not include an early indication of scheduling of CCs, and is not involved in adaptive WB configuration activation. All four CCs are activated, and all four CCs are assumed to have scheduled activity. Therefore, the BB clock may be set by the UE to sustain peak throughput for maximum bandwidth.

In example table 1000, the latency optimized capability 1007 is associated with an adaptive WB configuration activation. The latency optimized capability 1007 may indicate that the UE supports all four CCs being activated, with a maximum scheduling bandwidth of 120 MHz. The latency optimized capability 1007 may indicate a k₀ value of zero slots and a k₁ value of one slot. The BB clock may be set in accordance with a bandwidth of 300 MHz during occasions of a maximum scheduling bandwidth of 120 MHz. This means that the UE can accomplish processing much faster than if the UE were setting a BB clock according to the maximum scheduling bandwidth of 120 MHz.

The set 1001 in example table 1000 may include the RF and BB power optimized capability 1008, which is associated with an adaptive WB configuration activation. The RF and BB power optimized capability 1008 may indicate that the UE supports all four CCs being activated with a maximum scheduling bandwidth of 120 MHz. The RF and BB power optimized capability 1008 may indicate a k₀ value of one slot, and a k₁ value of two slots which allows the UE additional time to adapt its frequency.

The set 1001 in example table 900 may include the BB power/latency optimized capability 1009, which is associated with an adaptive WB configuration activation. The BB power/latency optimized capability 1009 may indicate that the UE supports all four CCs being activated with a maximum scheduling bandwidth of 220 MHz. The BB power/latency optimized capability 1009 may indicate a k₀ value of zero slots, and a k₁ value of one slot. This means that while the BB clock is set at 220 MHz, the UE is it involved in some discarding of samples (e.g., received transmissions) until the UE decodes PDCCH, allowing the CCs without any scheduled activity to go to sleep, which may correspond to the sleep mode 906 of FIG. 9. This mode may be useful for bursts of high activity when the maximum bandwidth is relatively high relative to the number of activated bands and the slot offsets are low resulting in quick responses from the UE.

The set 1001 in example table 1000 may include the reduced capability mode 1010, which is associated with an adaptive WB configuration activation. The reduced capability mode 1010 may indicate that the UE supports all four CCs being activated with a maximum scheduling bandwidth of 220 MHz. The reduced capability mode 1010 may indicate a k₀ value of one slot, and a k₁ value of three slots to allow the UE additional time to process a transmission. The BB clock is set at 100 MHz, thereby reducing the capabilities of the UE to process larger bandwidths, such as the maximum of 220 MHz. This additional time may be utilized by the UE to process transmissions as it is in a reduced capability state of processing at 100 MHz.

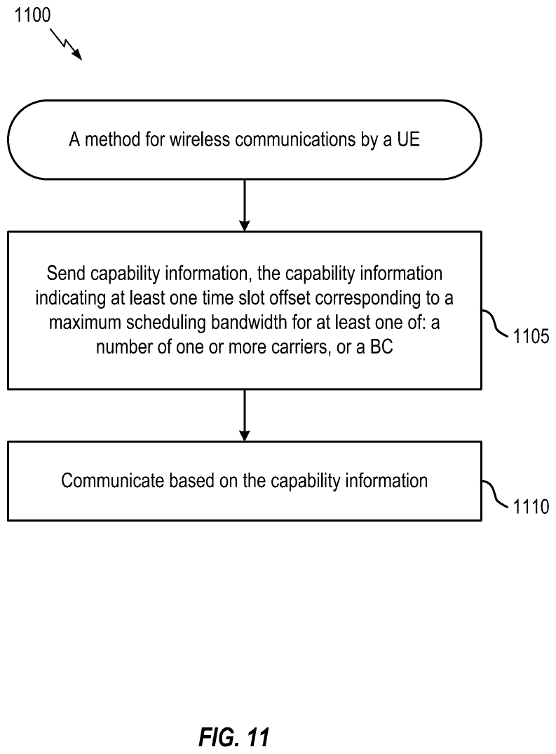

FIG. 11 shows a method 1100 for wireless communications by an apparatus, such as UE 104 of FIG. 1 or UE 304 of FIG. 3.

Method 1100 begins at block 1105 with sending capability information, the capability information indicating at least one time slot offset corresponding to a maximum scheduling bandwidth for at least one of: a number of one or more carriers, or a BC. For example, sending the capability information may correspond with the sending at 806 of FIG. 8 of capability information by the UE. The UE signaling its capabilities to the NE allows the NE to know the capabilities of the UE to tailor an adaptive WB configuration activation based on these capabilities to maximize efficiency and quality outcomes.

Method 1100 then proceeds to block 1110 with communicating based on the capability information. For example, this communicating may correspond with the communicating at 810 of FIG. 8 by the UE. This communicating at 1110 based on UE capability information may result in more efficient power consumption during the communication at 1110 since the UE may enter more efficient power states based on its capability information.

In one aspect, the number of the one or more carriers comprises a number of one or more activated carriers.

In one aspect, the one or more carriers comprise at least one CC of one or more CCs, or SB, of one or more SBs.

In one aspect, the one or more SBs comprise one of: a CC of the one or more CCs or at least one portion of the CC.

In one aspect, method 1100 further includes obtaining an indication of a WB configuration activation, wherein the WB configuration activation is based on the capability information, and wherein block 1110 includes communicating based on the WB configuration activation. The WB configuration activation may be an adaptive WB configuration activation described herein.

In one aspect, method 1100 further includes setting a BB clock based on the WB configuration activation.

In one aspect, the WB configuration activation indicates a UE state associated with a control channel configuration.

In one aspect, a UE state of the UE comprises at least one of a default state, a latency optimized state, or a power optimized state.

In one aspect, the default state comprises a first CCH configuration of a PDCCH on every activated carrier of the one or more carriers; the latency optimized state comprises a second CCH configuration of the PDCCH on an anchor CC of the one or more carriers and one additional carrier of the one or more carriers; and the power optimized state comprises a third CCH configuration of the PDCCH on one carrier of the one or more carriers.

In one aspect, method 1100 further includes setting a supply voltage or a BB based on the WB configuration activation.

In one aspect, the at least one time slot offset is associated with at least one of a first parameter, a second parameter, or a third parameter; the first parameter indicates a number of time slots between a PDCCH or a DCI and a downlink data transmission; the second parameter indicates a number of time slots between a PDSCH and a HARQ transmission; and the third parameter indicates a number of time slots between a PDCCH or a DCI and an uplink data transmission.

In one aspect, method 1100 further includes switching from a first UE state of the UE to a second UE state of the UE based on a delay exceeding a threshold, wherein the threshold is associated with the wideband activation configuration.

In one aspect, the indication of the WB configuration activation comprises first information and second information, wherein the first information is associated with the at least one time slot offset and the second information is associated with the one or more carriers.

In one aspect, the second information indicates the maximum scheduling bandwidth, and wherein the maximum scheduling bandwidth comprises information regarding at least one of: a maximum number of schedulable carriers of the one or more carriers in the BC, a maximum number of scheduled carriers of the one or more carriers in the BC, a maximum number of schedulable carriers of the one or more carriers per band in the BC, a maximum number of scheduled carriers of the one or more carriers per band in the BC, a scaling factor representing an actually scheduled bandwidth of the maximum scheduling bandwidth, or a scaling factor representing the maximum scheduled bandwidth.

In one aspect, the maximum scheduling bandwidth is a maximum actually scheduled bandwidth per band of the BC.

In one aspect, the maximum scheduling bandwidth is a maximum actually scheduled bandwidth of the BC.

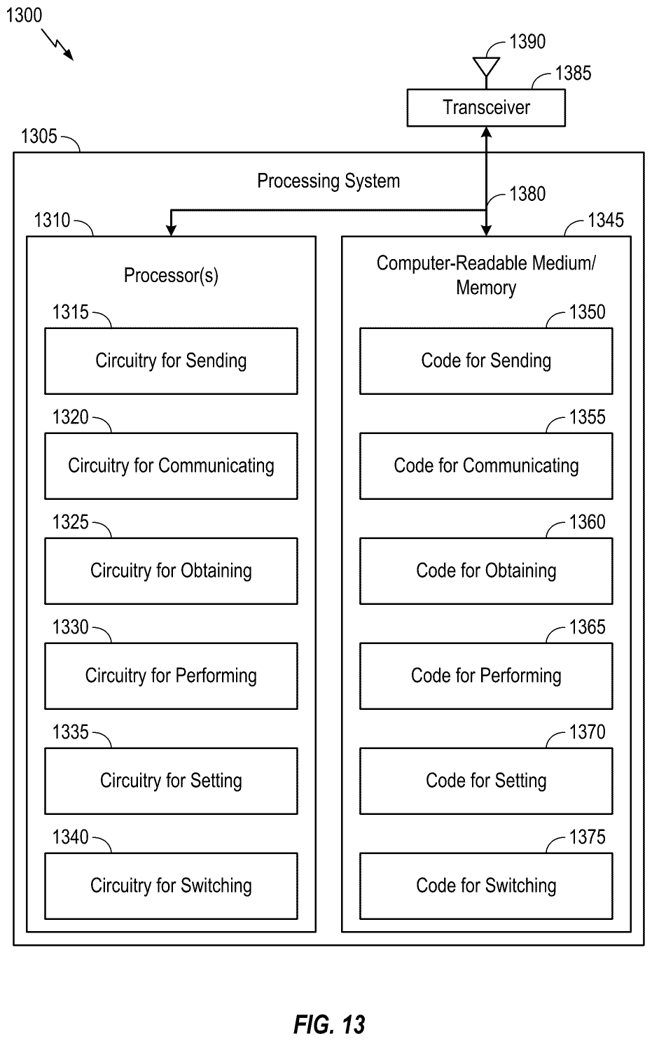

In one aspect, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure.

### Example Operations of a Network Entity

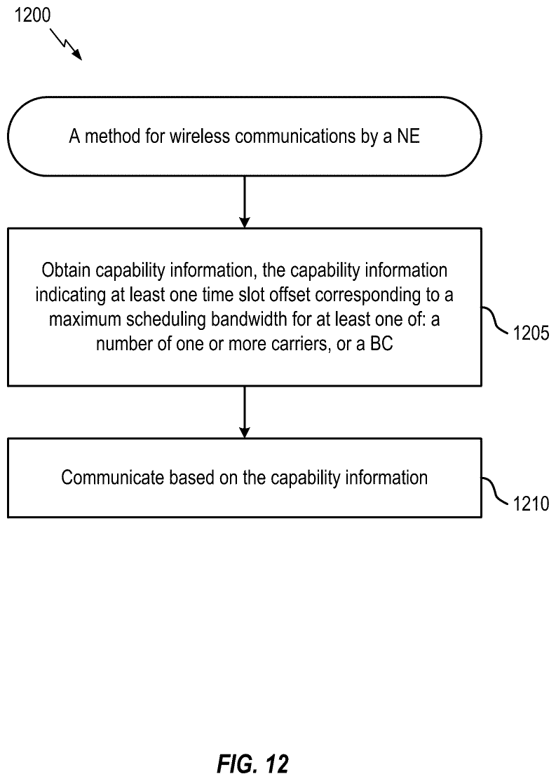

FIG. 12 shows a method 1200 for wireless communications by an apparatus, such as BS 102 of FIG. 1, a first network entity 300 or second network entity 302 of FIG. 3, or a disaggregated base station as discussed with respect to FIG. 2.

Method 1200 begins at block 1205 with obtaining capability information, the capability information indicating at least one time slot offset corresponding to a maximum scheduling bandwidth for at least one of: a number of one or more carriers, or a BC. For example, obtaining the capability information may correspond with the NE obtaining at 806 of FIG. 8 of capability information from the UE. The UE signaling its capabilities to the NE allows the NE to know the capabilities of the UE to tailor the adaptive WB configuration activation based on these capabilities to maximize efficiency and quality outcomes.

Method 1200 then proceeds to block 1210 with communicating based on the capability information. For example, the communicating by the NE may correspond with the NE indicating at 810 of FIG. 8 a WB configuration activation to the UE. The indication of the adaptive WB configuration activation may inform the UE of not only the CCs that are activated but may also indicate the scheduled transmissions on the activated CCs. The indication may allow the UE to respond proportionately and efficiently and not enter the highest power state automatically upon wideband activation.

In one aspect, the number of the one or more carriers comprise a number of activated carriers.

In one aspect, the one or more carriers comprise at least one of one or more CCs or one or more SBs.

In one aspect, the one or more SBs comprise one of: a CC of the one or more CCs or at least one portion of the CC.

In certain aspects, method 1200 further includes sending an indication of a WB configuration activation, wherein the WB configuration activation is based on the capability information.

In one aspect, the WB configuration activation indicates a UE state associated with a control channel configuration.

In one aspect, the at least one time slot offset is associated with at least one of a first parameter, a second parameter, or a third parameter, wherein the first parameter indicates a number of time slots between a PDCCH or a DCI and a downlink data transmission, wherein the second parameter indicates a number of time slots between a PDSCH and a HARQ transmission, and wherein the third parameter indicates a number of time slots between a PDCCH or a DCI and an uplink data transmission.

In one aspect, the indication of the WB configuration activation comprises first information and second information, wherein the first information is associated with the at least one time slot offset and the second information is associated with the one or more carriers.

In one aspect, the second information indicates the maximum scheduling bandwidth and the maximum scheduling bandwidth comprises information regarding at least one of: a maximum number of schedulable carriers of the one or more carriers in the BC, a maximum number of scheduled carriers of the one or more carriers in the BC, a maximum number of schedulable carriers of the one or more carriers per band in the BC, a maximum number of scheduled carriers of the one or more carriers per band in the BC, a scaling factor representing an actually scheduled bandwidth of the maximum scheduling bandwidth, or a scaling factor representing the maximum scheduled bandwidth.

In certain aspects, method 1200 further includes configuring monitoring of a CCH on at least one of the one or more carriers or an anchor carrier of the one or more carriers.

In certain aspects, method 1200 further includes sending, via a RRC signal, an indication of a configuration to utilize a plurality of UE states.

In certain aspects, method 1200 further includes sending, via lower layer signaling, an indication of a UE state.

In one aspect, the lower layer signaling comprises at least one of Layer 1 or Layer 2 signaling.

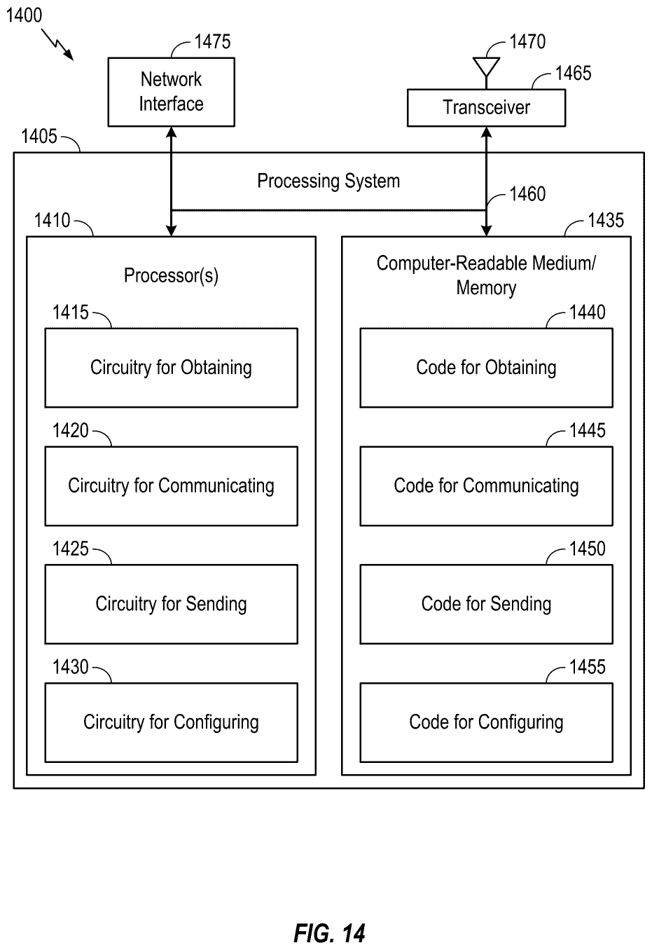

In one aspect, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative operations are possible consistent with this disclosure.

### Example Communications Devices

FIG. 13 depicts aspects of an example communications device 1300 configured for wireless communications. In some aspects, communications device 1300 is a user equipment, such as UE 104 described above with respect to FIG. 1 or UE 304 described with respect to FIG. 3.

The communications device 1300 includes a processing system 1305 coupled to a transceiver 1385 (e.g., a transmitter and/or a receiver). The transceiver 1385 is configured to transmit and receive signals for the communications device 1300 via an antenna 1390, such as the various signals as described herein. The processing system 1305 may be configured to perform processing functions for the communications device 1300, including processing signals received and/or to be transmitted by the communications device 1300.

The processing system 1305 includes one or more processors 1310 and a computer-readable medium/memory 1345. In various aspects, the one or more processors 1310 may be representative of the one or more processors 318 described with respect to FIG. 3. The one or more processors 1310 are coupled to a computer-readable medium/memory 1345 via a bus 1380. In some aspects, the computer-readable medium/memory 1345 may be representative of the one or more memories 320 described with respect to FIG. 3. The computer-readable medium/memory 1345 is a non-transitory computer-readable medium/memory. In certain aspects, the computer-readable medium/memory 1345 is configured to store instructions (e.g., computer-executable code), that when executed by the one or more processors 1310, cause the one or more processors 1310 to perform the method 1100 described with respect to FIG. 11, or any aspect related to it, including any operations described in relation to FIG. 11. Note that reference to a processor performing a function of communications device 1300 may include one or more processors performing that function of communications device 1300, such as in a distributed fashion.

In the depicted example, computer-readable medium/memory 1345 stores code (e.g., executable instructions), including code for sending 1350, code for communicating 1355, code for obtaining 1360, code for performing 1365, code for setting 1370, and code for switching 1375. Processing of the code 1350-1375 may enable and cause the communications device 1300 to perform the method 1100 described with respect to FIG. 11, or any aspect related to it.

The one or more processors 1310 include circuitry configured to implement (e.g., execute) the code stored in the computer-readable medium/memory 1345, including circuitry for sending 1315, circuitry for communicating 1320, circuitry for obtaining 1325, circuitry for performing 1330, circuitry for setting 1335, and circuitry for switching 1340. Processing with circuitry 1315-1340 may enable and cause the communications device 1300 to perform the method 1100 described with respect to FIG. 11, or any aspect related to it.

More generally, means for communicating, transmitting, sending or outputting for transmission may include the one or more transceivers 324, one or more antenna 322 and/or processing system 316 of the UE 304 illustrated in FIG. 3, transceiver 1385 and/or antenna 1390 of the communications device 1300 in FIG. 13, and/or one or more processors 1310 of the communications device 1300 in FIG. 13. Means for communicating, receiving or obtaining may include the one or more transceivers 324, one or more antennas 322, and/or processing system 316 of the UE 304 illustrated in FIG. 3, transceiver 1385 and/or antenna 1390 of the communications device 1300 in FIG. 13, and/or one or more processors 1310 of the communications device 1300 in FIG. 13.

FIG. 14 depicts aspects of an example communications device configured for wireless communications. In some aspects, communications device 1400 is a network entity, such as BS 102 of FIG. 1, first network entity 300 or second network entity 302 of FIG. 3, or a disaggregated base station as discussed with respect to FIG. 2.

The communications device 1400 includes a processing system 1405 coupled to a transceiver 1465 (e.g., a transmitter and/or a receiver) and/or a network interface 1475. The transceiver 1465 is configured to transmit and receive signals for the communications device 1400 via an antenna 1470, such as the various signals as described herein. The network interface 1475 is configured to obtain and send signals for the communications device 1400 via communications link(s), such as a backhaul link, midhaul link, and/or fronthaul link as described herein, such as with respect to FIG. 2. The processing system 1405 may be configured to perform processing functions for the communications device 1400, including processing signals received and/or to be transmitted by the communications device 1400.

The processing system 1405 includes one or more processors 1410 and a computer-readable medium/memory 1435. In various aspects, one or more processors 1410 may be representative of the one or more processors 308, as described with respect to FIG. 3. The one or more processors 1410 are coupled to the computer-readable medium/memory 1435 via a bus 1460. In certain aspects, the computer-readable medium/memory 1435 is configured to store instructions (e.g., computer-executable code), including code 1440-1455, that when executed by the one or more processors 1410, cause the one or more processors 1410 to perform the method 1200 described with respect to FIG. 12, or any aspect related to it, including any operations described in relation to FIG. 12. The computer-readable medium/memory 1435 is a non-transitory computer-readable medium/memory. Note that reference to a processor of communications device 1400 performing a function may include one or more processors of communications device 1400 performing that function, such as in a distributed fashion.

In the depicted example, the computer-readable medium/memory 1435 stores code (e.g., executable instructions), including code for obtaining 1440, code for communicating 1445, code for sending 1450, and code for configuring 1455. Processing of the code 1440-1455 may enable and cause the communications device 1400 to perform the method 1200 described with respect to FIG. 12, or any aspect related to it.

The one or more processors 1410 include circuitry configured to implement (e.g., execute) the code stored in the computer-readable medium/memory 1435, including circuitry for obtaining 1415, circuitry for communicating 1420, circuitry for sending 1425, and circuitry for configuring 1430. Processing with circuitry 1415-1430 may enable and cause the communications device 1400 to perform the method 1200 described with respect to FIG. 12, or any aspect related to it.

Various components of the communications device 1400 may provide means for performing the method 1200 described with respect to FIG. 12, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1465, antenna 1470, and/or network interface 1475 of the communications device 1400 in FIG. 14, and/or one or more processors 1410 of the communications device 1400 in FIG. 14. Means for communicating, receiving or obtaining may include the one or more transceivers 312, one or more antennas 314, and/or processing system 306 of the first network entity 300 or the second network entity 302 illustrated in FIG. 3, transceiver 1465, antenna 1470, and/or network interface 1475 of the communications device 1400 in FIG. 14, and/or one or more processors 1410 of the communications device 1400 in FIG. 14. For example, means for obtaining, communicating, sending, configuring or indicating of the method 1200 described with respect to FIG. 12, or any aspect related to it, may include circuitry for obtaining, code for obtaining, circuitry for communicating, code for communicating, circuitry for sending, code for sending, circuitry for configuring, code for configuring, circuitry for indicating, or code for indicating.

### Example Clauses

Implementation examples are described in the following numbered clauses:
Clause 1: A method for wireless communications by an apparatus comprising: sending capability information, the capability information indicating at least one time slot offset corresponding to a maximum scheduling bandwidth for at least one of: a number of one or more carriers, or a BC; and communicating based on the capability information.
Clause 2: The method of Clause 1, wherein the number of the one or more carriers comprises a number of one or more activated carriers.
Clause 3: The method of any one of Clauses 1-2, wherein the one or more carriers comprise at least one CC of one or more CCs, or SB, of one or more SBs.
Clause 4: The method of Clause 3, wherein the one or more SBs comprise one of: a CC of the one or more CCs or at least one portion of the CC.
Clause 5: The method of any one of Clauses 1-4, further comprising: obtaining an indication of a WB configuration activation, wherein the WB configuration activation is based on the capability information, and wherein communicating based on the capability information comprises communicating based on the WB configuration activation.
Clause 6: The method of Clause 5, further comprising: performing load balancing on the one or more carriers based on the WB configuration activation.
Clause 7: The method of Clause 5, further comprising: setting a BB clock based on the WB configuration activation.
Clause 8: The method of Clause 5, wherein the WB configuration activation indicates a UE state associated with a control channel configuration.
Clause 9: The method of Clause 8, wherein a UE state of the UE comprises at least one of a default state, a latency optimized state, or a power optimized state.
Clause 10: The method of Clause 9, wherein: the default state comprises a first CCH configuration of a PDCCH on every activated carrier of the one or more carriers; the latency optimized state comprises a second CCH configuration of the PDCCH on an anchor CC of the one or more carriers and one additional carrier of the one or more carriers; and the power optimized state comprises a third CCH configuration of the PDCCH on one carrier of the one or more carriers.
Clause 11: The method of Clause 5, further comprising: setting a supply voltage or a BB based on the WB configuration activation.
Clause 12: The method of Clause 5, wherein: the at least one time slot offset is associated with at least one of a first parameter, a second parameter, or a third parameter; the first parameter indicates a number of time slots between a PDCCH or a DCI and a downlink data transmission; the second parameter indicates a number of time slots between a PDSCH and a HARQ transmission; and the third parameter indicates a number of time slots between a PDCCH or a DCI and an uplink data transmission.
Clause 13: The method of Clause 5, further comprising: switching from a first UE state of the UE to a second UE state of the UE based on a delay exceeding a threshold, wherein the threshold is associated with the wideband activation configuration.
Clause 14: The method of Clause 5, wherein the indication of the WB configuration activation comprises first information and second information, wherein the first information is associated with the at least one time slot offset and the second information is associated with the one or more carriers.
Clause 15: The method of Clause 14, wherein the second information indicates the maximum scheduling bandwidth, and wherein the maximum scheduling bandwidth comprises information regarding at least one of: a maximum number of schedulable carriers of the one or more carriers in the BC, a maximum number of scheduled carriers of the one or more carriers in the BC, a maximum number of schedulable carriers of the one or more carriers per band in the BC, a maximum number of scheduled carriers of the one or more carriers per band in the BC, a scaling factor representing an actually scheduled bandwidth of the maximum scheduling bandwidth, or a scaling factor representing the maximum scheduled bandwidth.
Clause 16: The method of any one of Clauses 1-15, wherein the maximum scheduling bandwidth is a maximum actually scheduled bandwidth per band of the BC.
Clause 17: The method of any one of Clauses 1-16, wherein the maximum scheduling bandwidth is a maximum actually scheduled bandwidth of the BC.
Clause 18: A method for wireless communications by an apparatus comprising: obtaining capability information, the capability information indicating at least one time slot offset corresponding to a maximum scheduling bandwidth for at least one of: a number of one or more carriers, or a BC; and communicating based on the capability information.
Clause 19: The method of Clause 18, wherein the number of the one or more carriers comprise a number of activated carriers.
Clause 20: The method of any one of Clauses 18-19, wherein the one or more carriers comprise at least one of one or more CCs or one or more SBs.
Clause 21: The method of Clause 20, wherein the one or more SBs comprise one of: a CC of the one or more CCs or at least one portion of the CC.
Clause 22: The method of any one of Clauses 18-21, wherein the communicating based on the capability information comprises: sending an indication of a WB configuration activation, wherein the WB configuration activation is based on the capability information.
Clause 23: The method of Clause 22, wherein the WB configuration activation indicates a UE state associated with a control channel configuration.
Clause 24: The method of Clause 22, wherein the at least one time slot offset is associated with at least one of a first parameter, a second parameter, or a third parameter, wherein the first parameter indicates a number of time slots between a PDCCH or a DCI and a downlink data transmission, wherein the second parameter indicates a number of time slots between a PDSCH and a HARQ transmission, and wherein the third parameter indicates a number of time slots between a PDCCH or a DCI and an uplink data transmission.
Clause 25: The method of Clause 22, wherein the indication of the WB configuration activation comprises first information and second information, wherein the first information is associated with the at least one time slot offset and the second information is associated with the one or more carriers.
Clause 26: The method of Clause 25, wherein the second information indicates the maximum scheduling bandwidth and the maximum scheduling bandwidth comprises information regarding at least one of: a maximum number of schedulable carriers of the one or more carriers in the BC, a maximum number of scheduled carriers of the one or more carriers in the BC, a maximum number of schedulable carriers of the one or more carriers per band in the BC, a maximum number of scheduled carriers of the one or more carriers per band in the BC, a scaling factor representing an actually scheduled bandwidth of the maximum scheduling bandwidth, or a scaling factor representing the maximum scheduled bandwidth.
Clause 27: The method of any one of Clauses 18-26, further comprising: configuring monitoring of a CCH on at least one of the one or more carriers or an anchor carrier of the one or more carriers.
Clause 28: The method of any one of Clauses 18-27, further comprising: sending, via a RRC signal, an indication of a configuration to utilize a plurality of UE states.
Clause 29: The method of any one of Clauses 18-28, further comprising: sending, via lower layer signaling, an indication of a UE state.
Clause 30: The NE of Clause 29, wherein the lower layer signaling comprises at least one of Layer 1 or Layer 2 signaling.
Clause 31: One or more apparatuses, comprising: one or more memories comprising executable instructions; and one or more processors configured to execute the executable instructions and cause the one or more apparatuses to perform a method in accordance with any one of Clauses 1-30.
Clause 32: One or more apparatuses configured for wireless communications, comprising: one or more memories; and one or more processors, coupled to the one or more memories, configured to cause the one or more apparatuses to perform a method in accordance with any one of Clauses 1-30.
Clause 33: One or more apparatuses configured for wireless communications, comprising: one or more memories; and one or more processors, coupled to the one or more memories, configured to perform a method in accordance with any one of Clauses 1-30.
Clause 34: One or more apparatuses, comprising means for performing a method in accordance with any one of Clauses 1-30.
Clause 35: One or more non-transitory computer-readable media comprising executable instructions that, when executed by one or more processors of one or more apparatuses, cause the one or more apparatuses to perform a method in accordance with any one of Clauses 1-30.
Clause 36: One or more computer program products embodied on one or more computer-readable storage media comprising code for performing a method in accordance with any one of Clauses 1-30.
Clause 37: One or more apparatuses configured for wireless communications, comprising: a processing system that includes one or more processors and one or more memories coupled with the one or more processors, the processing system configured to cause the one or more apparatuses to perform a method in accordance with any one of Clauses 1-30.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining”may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

As used herein, unless stated otherwise, the term “or” is used in an inclusive sense. This inclusive usage of or is equivalent to “and/or”. Thus, when options are delineated using “or,” it permits the selection of one or more of the enumerated options concurrently. For example, if the document stipulates that a component may comprise option A or option B, it shall be understood to mean that the component may comprise option A, option B, or both option A and option B, and does not mean, unless stated expressly that the component includes either option A or option B. This inclusive interpretation ensures that all potential combinations of the options are permissible, rather than restricting the choice to a singular, exclusive option.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. A user equipment (UE), comprising:
a processing system that includes one or more processors and one or more memories coupled with the one or more processors, the processing system configured to cause the UE to:
send capability information, the capability information indicating at least one time slot offset corresponding to a maximum scheduling bandwidth for at least one of:
a number of one or more carriers, or
a band combination (BC); and
communicate based on the capability information.

2. The UE of claim 1, wherein the number of the one or more carriers comprises a number of one or more activated carriers.

3. The UE of claim 1, wherein the one or more carriers comprise at least one component carrier (CC) of one or more CCs, or sub-band (SB), of one or more SBs.

4. The UE of claim 3, wherein the one or more SBs comprise one of: a CC of the one or more CCs or at least one portion of the CC.

5. The UE of claim 1, wherein the processing system is further configured to cause the UE to:
obtain an indication of an adaptive wideband (WB) configuration activation,
wherein the adaptive WB configuration activation is based on the capability information,
wherein the processing system, to cause the UE to communicate based on the capability information, is configured to cause the UE to communicate based on the adaptive WB configuration activation.

6. The UE of claim 5, wherein the processing system is further configured to cause the UE to:
set a baseband (BB) clock based on the adaptive WB configuration activation,
set a supply voltage based on the adaptive WB configuration activation, or
switch from a first UE state of the UE to a second UE state of the UE based on a delay exceeding a threshold, wherein the threshold is associated with the adaptive WB configuration activation.

7. The UE of claim 5, wherein the WB configuration activation indicates a UE state associated with a control channel configuration.

8. The UE of claim 7, wherein a UE state of the UE comprises at least one of a default state, a latency optimized state, or a power optimized state.

9. The UE of claim 8, wherein:
the default state comprises a first control channel (CCH) configuration of a physical downlink control channel (PDCCH) on every activated carrier of the one or more carriers;
the latency optimized state comprises a second CCH configuration of the PDCCH on an anchor component carrier (CC) of the one or more carriers and one additional carrier of the one or more carriers; and
the power optimized state comprises a third CCH configuration of the PDCCH on one carrier of the one or more carriers.

10. The UE of claim 5, wherein:
the at least one time slot offset is associated with at least one of a first parameter, a second parameter, or a third parameter;
the first parameter indicates a number of time slots between a physical downlink control channel (PDCCH) or a downlink control information (DCI) and a downlink data transmission;
the second parameter indicates a number of time slots between a physical downlink shared channel (PDSCH) and a hybrid automatic repeat request (HARQ) transmission; and
the third parameter indicates a number of time slots between a PDCCH or a DCI and an uplink data transmission.

11. The UE of claim 5, wherein the indication of the WB configuration activation comprises first information and second information, wherein the first information is associated with the at least one time slot offset and the second information is associated with the one or more carriers.

12. The UE of claim 11, wherein the second information indicates the maximum scheduling bandwidth, and wherein the maximum scheduling bandwidth comprises information regarding at least one of:
a maximum number of schedulable carriers of the one or more carriers in the BC,
a maximum number of scheduled carriers of the one or more carriers in the BC,
a maximum number of schedulable carriers of the one or more carriers per band in the BC,
a maximum number of scheduled carriers of the one or more carriers per band in the BC,
a scaling factor representing an actually scheduled bandwidth of the maximum scheduling bandwidth, or
a scaling factor representing the maximum scheduled bandwidth.

13. The UE of claim 1, wherein the maximum scheduling bandwidth is at least one of a maximum actually scheduled bandwidth per band of the BC or a maximum actually scheduled bandwidth of the BC.

14. A network entity (NE) comprising:
a processing system that includes one or more processors and one or more memories coupled with the one or more processors, the processing system configured to cause the NE to:
obtain capability information, the capability information indicating at least one time slot offset corresponding to a maximum scheduling bandwidth for at least one of:
a number of one or more carriers, or
a band combination (BC); and
communicate based on the capability information.

15. The NE of claim 14, wherein to communicate based on the capability information the processing system is further configured to cause the NE to:
send an indication of an adaptive wideband (WB) configuration activation, wherein the adaptive WB configuration activation is based on the capability information.

16. The NE of claim 15, wherein the indication of the adaptive WB configuration activation comprises first information and second information, wherein the first information is associated with the at least one time slot offset and the second information is associated with the one or more carriers.

17. The NE of claim 14, wherein the processing system is configured further to cause the NE to:
configure monitoring of a control channel (CCH) on at least one of the one or more carriers or an anchor carrier of the one or more carriers.

18. The NE of claim 14, wherein the processing system is configured further to cause the NE to:
send, via a radio resource control (RRC) signal, an indication of a configuration to utilize a plurality of UE states.

19. A method for wireless communications by a user equipment (UE), comprising:
sending capability information, the capability information indicating at least one time slot offset corresponding to a maximum scheduling bandwidth for at least one of:
a number of one or more carriers, or
a band combination (BC); and
communicating based on the capability information.

20. The method of claim 19, further comprising:
obtaining an indication of an adaptive wideband (WB) configuration activation, wherein the adaptive WB configuration activation is based on the capability information, and wherein the communicating is based on the adaptive WB configuration activation.
